(19) United States
(12) Patent Application Publication
(10) Pub. No.: US 2010/0298448 A1
(43) Pub. Date: Nov. 25, 2010

(54) PENETRATION ENHANCERS FOR FUNGICIDAL AGENTS

(75) Inventors: Hans-Peter Krause, Hofheim (DE); Gerhard Schnabel, Elsenfeld (DE); Rainer Süssmann, Limburg (DE); Peter Baur, Schondorf (DE); Udo Bickers, Wietmarschen (DE); Kerstin Hesse, Bonn (DE)

Correspondence Address: Baker Donelson Bearman, Caldwell & Berkowitz, PC, 920 Massachusetts Ave, NW, Suite 900, Washington, DC, 20001, US

(73) Assignee: BAYER CROPSCIENCE AG, Monheim (DE)

(21) Appl. No.: 12/294,920

(22) PCT Filed: Mar. 28, 2007
(86) PCT No.: PCT/EP2007/002741

§ 371 Date: Jan. 24, 2009

(30) Foreign Application Priority Data
Mar. 29, 2006 (EP) 06006505.9
Mar. 16, 2007 (DE) 10 2007 013 363.6

(51) Int. Cl. A01N 25/30; A01P 3/00

(52) U.S. Cl. 514/785; 514/772

(57) ABSTRACT

Polyalkylene oxide derivates of the formula (I),

R^{a}—(CO)ₐ—[O]_{c}-A—(CO)_{b}—R^{b} (I)

in which the symbols and indices have the following meanings:
R^{a} is a C₈-C₃₀-hydrocarbon radical;
R^{b} is a C₈-C₃₀-hydrocarbon radical, such as C₈-C₃₀-alkyl, C₈-C₃₀-alkenyl, C₈-C₃₀-alkynyl;
a is 0 or 1;
b is 0 or 1;
c is 0 or 1 and
A is one or more alkylene oxide units.

Compounds of the invention are suitable for promoting the penetration of fungicidal active substances into plants.

The invention relates to the field of chemical crop protection, in particular the use of special surfactants as penetrants for fungicidal active substances, and fungicidal compositions containing these surfactants.

Substances which increase the penetration of agrochemical active substances through the cuticle of plants, also called penetrants, are valuable auxiliaries in chemical crop protection. Although various classes of substances are already known as penetrants (cf. e.g. WO 2005/104844), there is from various points of view a further need for compounds having such properties.

It is therefore an object of the invention to provide further substances having penetrant properties for fungicidal active substances.

Surfactants from the group consisting of the polyalkylene oxide dialkanoates and the use thereof in crop protection are known: in the area of herbicides, for example, from WO 01/97614 A, WO 01/97615 A2 and WO 02/49432 A1, the two last-mentioned documents using surfactants having at least 10 and 12 alkylene oxide units, respectively; in the area of fungicides, as wetting agents, from WO 98/48628 A1; and their insecticides, as wetting agents, in an aerosol application from JP 3272105 B2.

In addition, the use of surfactants from the group consisting of the polyalkylene oxide dialkanoates has been known to date only for the physical stabilization of microemulsion concentrates (WO 02/45507 A2), for the preparation of storage-stable formulations (JP 11100301 A), and for the emulsification of externally applied oil-based adjuvants (WO 94/24858 A1, WO 03/094613 A1).

It has now been found that special surfactants from this group are suitable as penetrants for fungicidal active substances.

The invention therefore relates to the use of polyalkylene oxide derivatives of the formula (I)

R^{a}—(CO)ₐ—[O]_{c}-A—(CO)_{b}—R^{b} (I)

for promoting the penetration of fungicidal active substances into plants, the symbols and indices in the formula (I) having the following meanings:
R^{a} is a C₈-C₃₀-hydrocarbon radical, preferably C₈-C₃₀-alkyl, C₈-C₃₀-alkenyl or C₈-C₃₀-alkynyl,
R^{b} is a C₈-C₃₀-hydrocarbon radical, such as C₈-C₃₀-alkyl, C₈-C₃₀-alkenyl or C₈-C₃₀-alkynyl;
a is 0 or 1;
b is 0 or 1;
c is 0 or 1 and
A is one or more alkylene oxide units.

Hydrocarbon radical preferably denotes an aliphatic, saturated or presaturated hydrocarbon radical, particularly preferably alkyl, alkylene and alkynyl, in particular alkyl having preferably 4 to 24, particularly preferably 8 to 18, C atoms, which is optionally substituted by halogen, preferably F and CI, or (C₁-C₄)-alkoxy groups.

The term alkylene oxide units is preferably understood as meaning units of C₂-C₁₀-alkylene oxides, such as ethylene oxide, propylene oxide, butylene oxide or hexylene oxide, it being possible for the units to be identical to or different from one another within the surfactant. Units of ethylene oxide and propylene oxide are particularly preferred and ethylene oxide is very particularly preferred.

If the surfactant (I) contains different alkylene oxide units, these may be arranged alternately, blockwise or randomly.

The compounds of the formula (I) preferably contain Aₙ alkylene oxide units, n≧1 and ≦600, preferably ≧3 and ≦400, particularly preferably ≧5 and ≦100, very particularly preferably ≧5 and ≦80.

The surfactant of the formula (I) preferably contains alkylene oxide units A of the formula (II),

-(EO)ₓ(RO)_{y}(EO)_{z}— (II)

in which
EO denotes an ethylene oxide unit,
RO denotes a unit —CHR^{x}—CHR^{Y}—O—, R^{x}, R^{y}, independently of one another, denoting H or (C₁-C₄)alkyl, preferably denoting H, methyl, ethyl, in particular RO denotes a propylene oxide unit (PO),
x denotes an integer from 0 to 600, preferably 1 to 50,
y denotes an integer from 0 to 600,
z denotes an integer from 0 to 600,
   the sum of (x+y+z)≧2 and ≦600, preferably ≧3 and ≦400, particularly preferably ≧5 and ≦100.

The abbreviations EO and PO in formula (II) denote an ethylene oxide unit and a propylene oxide unit, respectively, and also where they are used in other parts of the description.

Particularly preferred surfactants (I) are surfactants of the following formulae I-1) to I-3),
I-1) R^{a}—O-A-R^{b}, in which R^{a}, A and R^{b} are defined as in formula (I), preferably (C₈-C₃₀)alkyl-O-[(EO)ₓ(PO)_{y}]—(C₈-C₃₀)alkyl,
I-2) R^{a}—CO—O-A-R^{b}, in which R^{a}, A and R^{b} are defined as in formula (I), preferably (C₈-C₃₀)alkyl-CO—O-[(EO)ₓ(PO)_{y}]—(C₈-C₃₀)alkyl,
I-3) R^{a}—CO—O-A-CO—R^{b}, in which R^{a}, A and R^{b} are defined as in formula (I), preferably (C₈-C₃₀)alkyl-CO—O—[(EO)ₓ(PO)_{y}]—CO—(C₈-C₃₀)alkyl,
   in which
x is an integer from 0 to 600,
y is an integer from 0 to 600, and
x+y is an integer≧1 and ≦600, preferably from 3 to 400, particularly preferably 5-100, very particularly preferably 5-80.

Particularly preferably used surfactants are
I-11) (C₁₀-C₂₄) alkyl-O-[(EO)ₓ(PO)_{y}]—(C₁₀-C₂₄)alkyl
I-22) (C₉-C₂₃)alkyl-CO—O-[(EO)ₓ(PO)_{y}]—(C₁₀-C₂₄)alkyl
I-33) (C₉-C₂₃)alkyl-CO—O-[(EO)ₓ(PO)_{y}]—CO(C₉-C₂₃)alkyl,
   in which
x is an integer from 0 to 600,
y is an integer from 0 to 600, and
x+y is an integer 1 and 600, preferably 3-400, particularly preferably 5-100, very particularly preferably 5-80.

Surfactants of the formula (I) are known from the literature, for example from McCutcheon's, Emulsifiers & Detergents 1994, Vol. 1: North American Edition and Vol. 2, International Edition; McCutcheon Division, Glen Rock N.J. The surfactants mentioned herein are part of this description by reference. In addition, surfactants of the formula (I) are also commercially available, for example under the trade name Cithrol® from Croda or are readily accessible to the person skilled in the art by known synthesis reactions.

Particularly preferred polyalkylene oxide derivatives of the formula (I) are those of the formula (III)

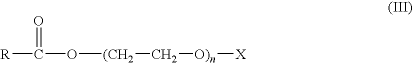

in which the symbols and indices have the following meanings:
R is an oleyl, stearyl or lauryl radical;
n is a natural number from 2 to 20 and

### X is H or —C(O)R.

These compounds are commercially available, for example, from the Cithrol® series of Croda.

Examples of preferred compounds of the formula (III) are:

| R | X | Molecular weight | Trade name (Cithrol ®-) | |
|---|---|---|---|---|
| Lauryl | H | 400 | 4 | ML |
| Lauryl | Lauryl | 400 | 4 | DL |
| Stearyl | H | 400 | 4 | MS |
| Stearyl | H | 600 | 6 | MS |
| Stearyl | H | 1000 | 10 | MS |
| Stearyl | Stearyl | 400 | 4 | DS |
| Olelyl | H | 200 | 2 | MO |
| Oleyl | H | 400 | 4 | MO |
| Oleyl | H | 600 | 6 | MO |
| Oleyl | H | 1000 | 10 | MO |
| Oleyl | Oleyl | 400 | 4 | DO |
| Oleyl | Oleyl | 600 | 6 | DOX |

Polyalkylene oxide derivatives of the formula (I), in which the indices a and b are equal to one, are very particularly preferred.

The commercially available products are general mixtures of compounds of the formula (I), in particular having different contents of alkylene oxide groups A, so that the value n usually represents a mean value.

Examples of surfactants of the formula (I) are listed in Tables 1 to 3 below:

TABLE 1
Surfactants of the formula I-1
R^{a}—O—A—R^{b}

| Ex. No. | R^{a} | A | R^{b} |
|---|---|---|---|
| 1 | C₈H₁₇ | (EO)₅ | C₈H₁₇ |
| 2 | C₈H₁₇ | (EO)₈ | C₈H₁₇ |
| 3 | C₈H₁₇ | (EO)₉ | C₈H₁₇ |
| 4 | C₈H₁₇ | (EO)₁₀ | C₈H₁₇ |
| 5 | C₈H₁₇ | (EO)₁₅ | C₈H₁₇ |
| 6 | C₈H₁₇ | (EO)₂₀ | C₈H₁₇ |
| 7 | C₈H₁₇ | (EO)₂₅ | C₈H₁₇ |
| 8 | C₈H₁₇ | (EO)₃₀ | C₈H₁₇ |
| 9 | C₈H₁₇ | (EO)₄₀ | C₈H₁₇ |
| 10 | C₈H₁₇ | (EO)₅₀ | C₈H₁₇ |
| 11 | C₁₀H₂₁ | (EO)₅ | C₁₀H₂₁ |
| 12 | C₁₀H₂₁ | (EO)₈ | C₁₀H₂₁ |
| 13 | C₁₀H₂₁ | (EO)₉ | C₁₀H₂₁ |
| 14 | C₁₀H₂₁ | (EO)₁₀ | C₁₀H₂₁ |
| 15 | C₁₀H₂₁ | (EO)₁₅ | C₁₀H₂₁ |
| 16 | C₁₀H₂₁ | (EO)₂₀ | C₁₀H₂₁ |
| 17 | C₁₀H₂₁ | (EO)₃₀ | C₁₀H₂₁ |
| 18 | C₁₀H₂₁ | (EO)₅₀ | C₁₀H₂₁ |
| 19 | C₁₀H₂₁ | (EO)₇₅ | C₁₀H₂₁ |
| 20 | C₁₀H₂₁ | (EO)₁₀₀ | C₁₀H₂₁ |
| 21 | C₁₂H₂₅ | (EO)₅ | C₁₂H₂₅ |
| 22 | C₁₂H₂₅ | (EO)₈ | C₁₂H₂₅ |
| 23 | C₁₂H₂₅ | (EO)₉ | C₁₂H₂₅ |
| 24 | C₁₂H₂₅ | (EO)₁₀ | C₁₂H₂₅ |
| 25 | C₁₂H₂₅ | (EO)₁₅ | C₁₂H₂₅ |
| 26 | C₁₂H₂₅ | (EO)₃₀ | C₁₂H₂₅ |
| 27 | C₁₂H₂₅ | (EO)₅₀ | C₁₂H₂₅ |
| 28 | C₁₄H₂₉ | (EO)₁₅ | C₁₄H₂₉ |
| 29 | C₁₄H₂₉ | (EO)₃₀ | C₁₄H₂₉ |
| 30 | C₁₄H₂₉ | (EO)₆₀ | C₁₄H₂₉ |
| 31 | C₁₄H₂₉ | (EO)₁₀₀ | C₁₄H₂₉ |
| 32 | C₁₆H₃₃ | (EO)₅ | C₁₆H₃₃ |
| 33 | C₁₆H₃₃ | (EO)₈ | C₁₆H₃₃ |
| 34 | C₁₆H₃₃ | (EO)₉ | C₁₆H₃₃ |
| 35 | C₁₆H₃₃ | (EO)₁₀ | C₁₆H₃₃ |
| 36 | C₁₆H₃₃ | (EO)₁₅ | C₁₆H₃₃ |
| 37 | C₁₆H₃₃ | (EO)₁₈ | C₁₆H₃₃ |
| 38 | C₁₆H₃₃ | (EO)₂₀ | C₁₆H₃₃ |
| 39 | C₁₆H₃₃ | (EO)₂₅ | C₁₆H₃₃ |
| 40 | C₁₆H₃₃ | (EO)₃₀ | C₁₆H₃₃ |
| 41 | C₁₆H₃₃ | (EO)₄₀ | C₁₆H₃₃ |
| 42 | C₁₆H₃₃ | (EO)₅₀ | C₁₆H₃₃ |
| 43 | C₁₆H₃₃ | (EO)₇₅ | C₁₆H₃₃ |
| 44 | C₁₆H₃₃ | (EO)₁₀₀ | C₁₆H₃₃ |
| 45 | C₁₈H₃₇ | (EO)₅ | C₁₈H₃₇ |
| 46 | C₁₈H₃₇ | (EO)₈ | C₁₈H₃₇ |
| 47 | C₁₈H₃₇ | (EO)₉ | C₁₈H₃₇ |
| 48 | C₁₈H₃₇ | (EO)₁₀ | C₁₈H₃₇ |
| 49 | C₁₈H₃₇ | (EO)₁₅ | C₁₈H₃₇ |
| 50 | C₁₈H₃₇ | (EO)₂₀ | C₁₈H₃₇ |
| 51 | C₁₈H₃₇ | (EO)₂₅ | C₁₈H₃₇ |
| 52 | C₁₈H₃₇ | (EO)₃₀ | C₁₈H₃₇ |
| 53 | C₁₈H₃₇ | (EO)₄₀ | C₁₈H₃₇ |
| 54 | C₁₈H₃₇ | (EO)₅₀ | C₁₈H₃₇ |
| 55 | C₁₈H₃₇ | (EO)₆₀ | C₁₈H₃₇ |
| 56 | C₁₈H₃₇ | (EO)₇₅ | C₁₈H₃₇ |
| 57 | C₁₈H₃₇ | (EO)₁₀₀ | C₁₈H₃₇ |
| 58 | C₁₈H₃₇ | (EO)₁₅₀ | C₁₈H₃₇ |
| 59 | C₁₈H₃₇ | (EO)₂₀₀ | C₁₈H₃₇ |
| 60 | C₂₂H₄₅ | (EO)₅ | C₂₂H₄₅ |
| 61 | C₂₂H₄₅ | (EO)₈ | C₂₂H₄₅ |
| 62 | C₂₂H₄₅ | (EO)₉ | C₂₂H₄₅ |
| 63 | C₂₂H₄₅ | (EO)₁₀ | C₂₂H₄₅ |
| 64 | C₂₂H₄₅ | (EO)₂₅ | C₂₂H₄₅ |
| 65 | C₂₂H₄₅ | (EO)₅₀ | C₂₂H₄₅ |
| 66 | C₂₂H₄₅ | (EO)₁₀₀ | C₂₂H₄₅ |
| 67 | C₁₈H₃₇ | (EO)₁₅(PO)₅ | C₁₈H₃₇ |
| 68 | C₁₈H₃₇ | (EO)₂₀(PO)₅ | C₁₈H₃₇ |
| 69 | C₁₈H₃₇ | (EO)₁₅(PO)₁₀ | C₁₈H₃₇ |
| 70 | C₁₈H₃₇ | (EO)₁₅(PO)₁₅ | C₁₈H₃₇ |
| 71 | C₁₈H₃₇ | (EO)₃₀(PO)₁₀ | C₁₈H₃₇ |
| 72 | C₁₈H₃₅ | (EO)₂₅ | C₁₈H₃₅ |
| 73 | C₁₈H₃₅ | (EO)₅₀ | C₁₈H₃₅ |
| 74 | C₁₈H₃₃ | (EO)₅ | C₁₈H₃₃ |
| 75 | C₁₈H₃₃ | (EO)₈ | C₁₈H₃₃ |
| 76 | C₁₈H₃₃ | (EO)₉ | C₁₈H₃₃ |
| 77 | C₁₈H₃₃ | (EO)₁₀ | C₁₈H₃₃ |
| 78 | C₁₈H₃₃ | (EO)₂₅ | C₁₈H₃₃ |
| 79 | C₁₈H₃₃ | (EO)₅₀ | C₁₈H₃₃ |
| 80 | C₁₈H₃₇ | (EO)₂₀ | C₈H₁₇ |
| 81 | C₁₈H₃₇ | (EO)₂₅ | C₈H₁₇ |
| 82 | C₁₈H₃₇ | (EO)₅₀ | C₈H₁₇ |

TABLE 2
Surfactants of the formula I-2
R^{a}—CO—O—A—R^{b}

| Ex. No. | R^{a} | A | R^{b} |
|---|---|---|---|
| 1 | C₉H₁₉ | (EO)₁₀ | C₈H₁₇ |
| 2 | C₉H₁₉ | (EO)₁₅ | C₈H₁₇ |
| 3 | C₉H₁₉ | (EO)₂₀ | C₈H₁₇ |
| 4 | C₉H₁₉ | (EO)₃₀ | C₈H₁₇ |
| 5 | C₉H₁₉ | (EO)₅₀ | C₈H₁₇ |
| 6 | C₉H₁₉ | (EO)₅ | C₁₂H₂₅ |
| 7 | C₉H₁₉ | (EO)₈ | C₁₂H₂₅ |
| 8 | C₉H₁₉ | (EO)₉ | C₁₂H₂₅ |
| 9 | C₉H₁₉ | (EO)₁₀ | C₁₂H₂₅ |
| 10 | C₉H₁₉ | (EO)₃₀ | C₁₂H₂₅ |
| 11 | C₉H₂₃ | (EO)₁₅ | C₈H₁₇ |
| 12 | C₉H₂₃ | (EO)₃₀ | C₈H₁₇ |
| 13 | C₉H₂₃ | (EO)₆₀ | C₈H₁₇ |
| 14 | C₉H₂₃ | (EO)₂₀ | C₁₂H₂₅ |
| 15 | C₉H₂₃ | (EO)₃₀ | C₁₄H₂₉ |
| 16 | C₁₃H₂₇ | (EO)₃₀ | C₈H₁₇ |
| 17 | C₁₃H₂₇ | (EO)₃₀ | C₁₄H₂₉ |
| 18 | C₁₃H₂₇ | (EO)₂₅ | C₁₂H₂₅ |
| 19 | C₁₅H₃₁ | (EO)₂₀ | C₁₆H₃₃ |
| 20 | C₁₅H₃₁ | (EO)₃₀ | C₁₆H₃₃ |
| 21 | C₁₇H₃₅ | (EO)₅ | C₁₆H₃₃ |
| 22 | C₁₇H₃₅ | (EO)₈ | C₁₆H₃₃ |
| 23 | C₁₇H₃₅ | (EO)₉ | C₁₆H₃₃ |
| 24 | C₁₇H₃₅ | (EO)₁₀ | C₁₆H₃₃ |
| 25 | C₁₇H₃₅ | (EO)₁₅ | C₁₆H₃₃ |
| 26 | C₁₇H₃₅ | (EO)₂₀ | C₁₆H₃₃ |
| 27 | C₁₇H₃₅ | (EO)₅ | C₁₆H₃₃ |
| 28 | C₁₇H₃₅ | (EO)₉ | C₁₆H₃₃ |
| 29 | C₁₇H₃₅ | (EO)₁₀ | C₁₆H₃₃ |
| 30 | C₁₇H₃₅ | (EO)₃₀ | C₁₆H₃₃ |
| 31 | C₁₇H₃₅ | (EO)₄₀(PO)₁₀ | C₁₆H₃₃ |
| 32 | C₁₇H₃₅ | (EO)₄₀(PO)₂₀ | C₁₆H₃₃ |

TABLE 3
Surfactants of the formula I-3
R^{a}—CO—O—A—CO—R^{b}

| Ex. No. | R^{a} | A | R^{b} |
|---|---|---|---|
| 1 | C₉H₁₉ | (EO)₁₀ | C₉H₁₉ |
| 2 | C₉H₁₉ | (EO)₁₅ | C₉H₁₉ |
| 3 | C₉H₁₉ | (EO)₂₀ | C₉H₁₉ |
| 4 | C₉H₁₉ | (EO)₄₀ | C₉H₁₉ |
| 5 | C₉H₂₃ | (EO)₅ | C₉H₂₃ |
| 6 | C₉H₂₃ | (EO)₈ | C₉H₂₃ |
| 7 | C₉H₂₃ | (EO)₉ | C₉H₂₃ |
| 8 | C₉H₂₃ | (EO)₁₀ | C₉H₂₃ |
| 9 | C₉H₂₃ | (EO)₂₀ | C₉H₂₃ |
| 10 | C₉H₂₃ | (EO)₃₀ | C₉H₂₃ |
| 11 | C₉H₂₃ | (EO)₄₀ | C₉H₂₃ |
| 12 | C₉H₂₃ | (EO)₅₀ | C₉H₂₃ |
| 13 | C₉H₂₃ | (EO)₅ | C₉H₂₃ |
| 14 | C₁₃H₂₇ | (EO)₈ | C₁₃H₂₇ |
| 15 | C₁₃H₂₇ | (EO)₉ | C₁₃H₂₇ |
| 16 | C₁₃H₂₇ | (EO)₁₀ | C₁₃H₂₇ |
| 17 | C₁₃H₂₇ | (EO)₂₀ | C₁₃H₂₇ |
| 18 | C₁₃H₂₇ | (EO)₃₀ | C₁₃H₂₇ |
| 19 | C₁₃H₂₇ | (EO)₄₀ | C₁₃H₂₇ |
| 20 | C₁₃H₂₇ | (EO)₅₀ | C₁₃H₂₇ |
| 21 | C₁₃H₂₇ | (EO)₆₀ | C₁₃H₂₇ |
| 22 | C₁₅H₃₁ | (EO)₅ | C₁₅H₃₁ |
| 23 | C₁₅H₃₁ | (EO)₈ | C₁₅H₃₁ |
| 24 | C₁₅H₃₁ | (EO)₉ | C₁₅H₃₁ |
| 25 | C₁₅H₃₁ | (EO)₁₅ | C₁₅H₃₁ |
| 26 | C₁₅H₃₁ | (EO)₂₀ | C₁₅H₃₁ |
| 27 | C₁₅H₃₁ | (EO)₃₀ | C₁₅H₃₁ |
| 28 | C₁₅H₃₁ | (EO)₄₀ | C₁₅H₃₁ |
| 29 | C₁₅H₃₁ | (EO)₅₀ | C₁₅H₃₁ |
| 30 | C₁₅H₃₁ | (EO)₆₀ | C₁₅H₃₁ |
| 31 | C₁₅H₃₁ | (EO)₁₀₀ | C₁₅H₃₁ |
| 32 | C₁₇H₃₅ | (EO)₅ | C₁₇H₃₅ |
| 33 | C₁₇H₃₅ | (EO)₈ | C₁₇H₃₅ |
| 34 | C₁₇H₃₅ | (EO)₉ | C₁₇H₃₅ |
| 35 | C₁₇H₃₅ | (EO)₁₅ | C₁₇H₃₅ |
| 36 | C₁₇H₃₅ | (EO)₂₀ | C₁₇H₃₅ |
| 37 | C₁₇H₃₅ | (EO)₃₀ | C₁₇H₃₅ |
| 38 | C₁₇H₃₅ | (EO)₄₀ | C₁₇H₃₅ |
| 39 | C₁₇H₃₅ | (EO)₅₀ | C₁₇H₃₅ |
| 40 | C₁₇H₃₅ | (EO)₆₀ | C₁₇H₃₅ |
| 41 | C₁₇H₃₅ | (EO)₇₀ | C₁₇H₃₅ |
| 42 | C₁₇H₃₅ | (EO)₁₀₀ | C₁₇H₃₅ |
| 43 | C₁₇H₃₃ | (EO)₂₀ | C₁₇H₃₃ |
| 44 | C₁₇H₃₁ | (EO)₃ | C₁₇H₃₁ |
| 45 | C₁₇H₃₁ | (EO)₅ | C₁₇H₃₁ |
| 46 | C₁₇H₃₁ | (EO)₈ | C₁₇H₃₁ |
| 47 | C₁₇H₃₁ | (EO)₉ | C₁₇H₃₁ |
| 48 | C₁₇H₃₁ | (EO)₁₀ | C₁₇H₃₁ |
| 49 | C₁₇H₃₁ | (EO)₁₂ | C₁₇H₃₁ |
| 50 | C₁₇H₃₁ | (EO)₂₀ | C₁₇H₃₁ |
| 51 | C₁₇H₃₁ | (EO)₂₀ | C₁₃H₂₇ |

The term penetrant is understood as meaning compounds which promote the absorption of fungicidal active substances through the cuticle of a plant into the plant, i.e. accelerate the absorption rate and/or increase the amount of active substance absorbed into the plant.

Since the action mechanism of the surfactants (I) as penetrants is in principle independent of the type of fungicidal active substance used, suitable active substances are all those whose biological activity can be increased by increased penetration into a cultivated or noxious plant.

Fungicides and bactericides which have systemic properties, and contact compositions suitable as combination partners, may preferably be mentioned. Below, the term fungicides includes both fungicides and bactericides-unless otherwise evident from the context.

Systemic active substances, i.e. those which are absorbed by the plant through the leaves or via the roots and are passed on in the sap stream, the transport system or plant, are also preferred. Those active substances which have a log P value of ≦4 (determined according to EEC Directive 79/831 Annex V. A8 by HPLC, gradient method, acetonitrile/0.1% aqueous phosphoric acid), are particularly preferred, in particular those having a log P value≦4 and ≧0.1.

Examples of individual fungicidal active substances are:

Inhibitors of nucleic acid synthesis, in particular
benalaxyl, benalaxyl-M, bupirimat, chiralaxyl, clozylacon, dimethirimol, ethirimol, furalaxyl, hymexazol, metalaxyl, metalaxyl-M, ofurace, oxadixyl, oxolinic acid
   Inhibitors of mitosis and cell division, in particular
benomyl, carbendazim, diethofencarb, fuberidazole, pencycuron, thiabendazole, thiophanat-methyl, zoxamid
   Inhibitors of the respiratory chain complex I, in particular
diflumetorim
   Inhibitors of the respiratory chain complex II, in particular
boscalid, carboxin, fenfuram, flutolanil, furametpyr, mepronil, oxycarboxin, penthiopyrad, thifluzamid
   Inhibitors of the respiratory chain complex III, in particular
azoxystrobin, cyazofamid, dimoxystrobin, enestrobin, famoxadon, fenamidon, fluoxastrobin, kresoximmethyl, metominostrobin, orysastrobin, pyraclostrobin, picoxystrobin, trifloxystrobin
   Decouplers, in particular
dinocap, fluazinam
   Inhibitors of ATP production, in particular
fentin acetate, fentin chloride, fentin hydroxide, silthiofam
   Inhibitors of amino acid and protein biosynthesis, in particular
andoprim, blasticidin-S, cyprodinil, kasugamycin, kasugamycin hydrochloride hydrate, mepanipyrim, pyrimethanil
   Inhibitors of signal transduction, in particular
fenpiclonil, fludioxonil, quinoxyfen
   Inhibitors of fat and membrane synthesis, in particular
chiozolinate, iprodione, procymidon, vinclozolin
ampropylfos, potassium-ampropylfos, edifenphos, iprobenfos (IBP),
isoprothiolane, pyrazophos
tolclofos-methyl, biphenyl
iodocarb, propamocarb, propamocarb hydrochloride
   Inhibitors of ergosterol biosynthesis, in particular
fenhexamide,
azaconazole, bitertanol, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidol, nuarimol, pyrifenox, triforin, pefurazoate, prochloraz, triflumizole, viniconazole, aldimorph, dodemorph, dodemorph acetate, fenpropimorph, tridemorph, fenpropidin, spiroxamine,
naftifin, pyributicarb, terbinafin
   Inhibitors of cell wall synthesis, in particular
benthiavalicarb, bialaphos, dimethomorph, flumorph, iprovalicarb, polyoxins, polyoxorim, validamycin A
   Inhibitors of melanine biosynthesis, in particular
capropamide, diclocymet, fenoxanil, phthalide, pyroquilon, tricyclazole
   Resistance inducers, in particular
acibenzolar-S-methyl, probenazole, tiadinil
   Multisite, in particular
captafol, captan, chlorothalonil, copper salts, such as: copper hydroxide, copper naphthenate, copper oxychloride, copper sulphate, copper oxide, oxine-copper and Bordeaux mixture, dichlofluanid, dithianon, dodine, dodine free base, ferbam, folpet, fluorofolpet, guazatin, guazatin acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram
   Fungicides having an unknown mechanism, in particular
amibromdole, benthiazole, bethoxazin, capsimycin, carvon, quinomethionate, chloropicrin, cufraneb, cyflufenamide, cymoxanil, dazomet, debacarb, diclomezine, dichlorophen, dicloran, difenzoquat, difenzoquat methylsulphate, diphenylamine, ethaboxam, ferimzon, flumetover, flusulfamide, fluopicolide, fluoroimide, hexachlorobenzene, 8-hydroxyquinoline sulphate, irumamycin, methasulphocarb, metrafenone, methyl isothiocyanate, mildiomycin, natamycin, nickel dimethyldithiocarbamate, nitrothal-isopropyl, octhilinone, oxamocarb, oxyfenthiine, pentachlorophenol and salts, 2-phenylphenol and salts, piperaline, propanosine-sodium, proquinazide, pyrroInitrin, quintozen, tecloftalam, tecnazen, triazoxide, trichlamide, zarilamide and 2,3,5,6-tetrachloro-4-(methylsulphonyl)pyridine, N-(4-chloro-2-nitrophenyl)-N-ethyl-4-methylbenzene-sulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3-(trifluoromethyl)phenyl]ethylidene]amino]oxy]methyl]phenyl[-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-alpha-(methoxy-methylene)benzacetate, 4-chloro-alpha-propynyloxy-N-[2-[4-[[3-methoxy-4-(2-propynyl]oxy)phenyl]ethyl]benzacetamide, (2S)—N-[2-[4-[[3-(4-chlorophenyl)-2-propynyl]oxy]-3-methoxyphenyl]ethyl]-3-methyl-2-[(methylsulphonyl)amino]-butanamide, 5-chloro-7-(4-methylpiperidin-1-yl)-6-(2,4,6-trifluorophenyl)-[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl) [1,2,4]triazolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyl-benzopyranon-4-one, N-{(Z)-[(cyclopropylmethoxy)imino][6-(difluoromethoxy)-2,3-difluorophenyl]methyl}-2-benzacetamide, N-(3-ethyl-3,5,5-trimethylcyclo-hexyl)-3-formylamino-2-hydroxybenzamide, 2-[[[[1-[3(1-fluoro-2-phenylethyl)oxy]phenyl]ethylidene]amino]oxy]methyl]-alpha-(methoxyimino)-N-methyl-alphaE-benzacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methylacetamide

The fungicidal active substances may also be bactericides, for example bronopol, dichlorophen, nitrapyrine, nickel dimethyldithiocarbamate, kasugamycin, octhilinone, furancarboxylic acid, oxytetracycline, probenazole, streptomycin, tecloftalam, copper sulphate and other copper formulations.

The invention furthermore relates to fungicidal compositions containing at least one fungicidal active substance (A) and at least one surfactant (B) of the formula (I). The fungicidal compositions according to the invention show an excellent action and, if a preferred embodiment, synergistic effects. Owing to the improved control of the pest organisms by the insecticidal compositions according to the invention, it is possible to reduce the amount applied and/or to increase the safety margin. Both are economically as well as ecologically expedient. The choice of the amounts of the components (A)+(B) to be used and the ratio of the components (A):(B) are dependant on a whole series of factors.

The suitable formulation types include all formulations which are applied to plants or the reproductive material thereof. The processes used for the preparation thereof are generally familiar to the person skilled in the art and are described, for example, in Winnacker-Küchler, “Chemische Technologie [Chemical Technology]”, Vol. 7, C. Hanser Verlag, Munich, 4th Edition, 1986; J. W. van Valkenburg, “Pesticide Formulations”, Marcel Dekker N.Y., 1973, K. Martens, “Spray Drying Handbook”, 3rd Ed. 1979, G. Goodwin Ltd., London, or Mollet, Grubenmann, “Formulierungstechnik [Formulation Technology, Wiley-VCH-Verlag, Weinheim, 2000.

Examples of formulation types are mentioned in “Manual on development and use of FAO and WHO specifications for pesticides” (FAO and WHO, 2002, Appendix E) (in each case use of the GCPF formulation codes with English abbreviation and designation): AL Any other liquid; AP Any other powder; CF Capsule Suspension for Seed Treatment; CG Encapsulated granule; CL Contact liquid or gel; CP Contact powder; CS Capsule suspension; DC Dispersible concentrate; DP Dustable powder; DS Powder for dry seed treatment; EC Emulsifiable concentrate; ED Electrochargeable liquid; EG Emulsifiable Granule; EO Emulsion, water in oil; EP emulsifiable powder; ES Emulsion for seed treatment; EW Emulsion, oil in water; FG Fine granule; FS Flowable concentrate for seed treatment; GF Gel for Seed Treatment; GG Macrogranule; GL Emulsifiable gel; GP Flo-dust; GR Granule; GS Grease; GW Water soluble gel; HN Hot fogging concentrate; KK Combi-pack solid/liquid; KL Combi-pack liquid/liquid; KN Cold fogging concentrate; KP Combi-pack solid/solid; LA Lacquer; LS Solution for seed treatment; MG microgranule; OD oil dispersion; OF Oil miscible flowable concentrate/oil miscible suspension; OL Oil miscible liquid; OP Oil dispersible powder; PA Paste; PC Gel or paste concentrate; PO Pour-on; PR Plant rodlet; PT Pellet; SA Spot-on; SC suspension concentrate; SD suspension concentrate for direct application; SE Suspo-emulsion; SG Water soluble granule; SL Soluble concentrate; SO Spreading oil; SP Water soluble powder; SS Water soluble powder for seed treatment; ST Water soluble tablet; SU Ultra-low volume (ULV) suspension; TB Tablet; TC Technical material; TK Technical concentrate; UL Ultra-low volume (ULV) liquid; WG Water dispersible granules; WP Wettable powder; WS Water dispersible powder for slurry seed treatment; WT Water dispersible tablet; XX Others.

Liquid formulation types are preferred. These include the formulation types DC (GCPF formulation code for dispersible concentrate); EC (GCPF formulation code for emulsion concentrate); EW (GCPF formulation code for oil-in-water emulsion); ES (GCPF formulation code for emulsion treatment); FS (GCPF formulation code for multiphase concentrate for seed treatment); EO (GCPF formulation code for water-in-oil emulsion); OD (GCPF formulation code for oil dispersions); SE (GCPF formulation code for suspo-emulsion); SL (GCPF formulation code for water-soluble concentrate); CS (GCPF formulation code for capsule suspension) and AL (GCPF formulation code for ready-to-use liquid formulation, other liquids for undiluted application).

Emulsion concentrates (as formulation type EC) and oil dispersions (as formulation type OD) are particularly preferred.

Suitable additives which may be present in the preferably liquid formulations according to the invention are all customary formulation auxiliaries such as organic solvents, antifoams, emulsifiers, dispersants, preservatives, acids and bases, dyes, fillers and also water.

Suitable antifoams are customary antifoams present in formulations of agrochemical active substances. Silicone oils, dispersions of silicone oils, magnesium stearate, phosphinic and phosphonic acids, in particular Fluowet PL 80®, may be mentioned by way of example.

Suitable organic solvents or dispersants are all customary organic solvents. Aliphatic and aromatic, optionally halogenated hydrocarbons, such as toluene, xylene, Solvesso®, mineral oils, such as mineral spirit, petroleum, alkylbenzenes and spindle oil, and furthermore tetrachloromethane, chloroform, methylene chloride and dichloromethane, and also esters, such as ethyl acetate, lactates and furthermore lactones, such as butyrolactone, and also lactams, such as N-methylpyrrolidone, N-octylpyrrolidone, N-dodecylpyrrolidone, N-octylcaprolactam and N-methyl-caprolactam, γ-butyrolactone, dimethylformamide and tributyl phosphate, and also triglycerides, such as animal and vegetable fats and oils, and the transesterification products thereof, such as fatty acid alkyl esters, may be mentioned as being preferred.

Suitable emulsifiers are customary surface-active substances present in formulations of agrochemical active substances. Ethoxylated nonylphenols, polyethylene glycol ethers of linear alcohols, endcapped and non-endcapped alkoxylated linear and branched saturated and unsaturated alcohols, reaction products of alkylphenols with ethylene oxide and/or propylene oxide, ethylene oxide/propylene oxide block copolymers, polyethylene glycols and polypropylene glycols, and furthermore fatty acid esters, endcapped and non-endcapped alkoxylated linear and branched saturated and unsaturated fatty acids, alkylsulphonates, alkylsulphates, arylsulphates, ethoxylated arylalkylphenols, such as, for example, tristyrylphenol ethoxylate having an average 16 ethylene oxide units per molecule, and furthermore ethoxylated and propoxylated arylalkylphenols and sulphated or phosphated arylalkylphenol ethoxylates or ethoxylates and propoxylates may be mentioned by way of example.

Suitable dispersants are all customary substances used for this purpose in crop protection agents. In addition to the examples mentioned above under emulsifiers, natural and synthetic water-soluble polymers, such as gelatin, starch and cellulose derivatives, in particular cellulose esters and cellulose ethers, and furthermore polyvinyl alcohol, polyvinylpyrrolidone, polyacrylic acid, polymethacrylic acid and copolymers of (meth)acrylic acid and (meth)acrylates, and also copolymers of methacrylic acid and methacrylates which are neutralized with alkali metal hydroxide, and also ionic polymers, such as ligninsulphonates and condensates of alkylnaphthalenesulphonates with formaldehyde, may be mentioned as being preferred.

Suitable preservatives are all substances usually present for this purpose in crop treatment agents. Preventol® and Proxel® may be mentioned as examples.

Suitable dyes are all inorganic or organic dyes customary for the preparation of crop protection agents. Fatty titanium dioxide, Farbruss, zinc oxide and blue pigments may be mentioned by way of example.

Suitable fillers are all substances usually used for this purpose in crop protection agents. Inorganic particles, such as carbonates, silicates and oxides having a mean particle size of 0.005 to 5 μm, particularly preferably of 0.02 to 2 μm, may be mentioned as being preferred. Silica, so-called finely divided silica, silica gels and natural and synthetic silicates and alumosilicates may be mentioned by way of example.

Suitable compounds which act as emulsion stabilizers and/or crystallization inhibitors are all substances usually used for this purpose in crop protection agents.

The content of the initial components can be varied within a relatively large range in the formulations according to the invention.

The preparation of the crop protection agents according to the invention is effected, for example, by mixing the components with one another in the ratios desired in each case. If the fungicidal active substance is a solid substance, it is used in general either in finely milled form or in the form of a solution or suspension in an organic solvent or water. If the fungicidal active substance is liquid, the use of an organic solvent is frequently superfluous. It is also possible to use a solid fungicidal active substance in the form of a melt.

The temperatures can be varied within a certain range when carrying out the process. In general, temperatures between 0° C. and 80° C., preferably between 10° C. and 60° C., are employed.

For the preparation of compositions according to the invention, a procedure is generally adopted in which the polyalkylene derivatives (I) are mixed with one or more active substances and optionally with additives. The sequence in which the components are mixed with one another is arbitrary.

Customary apparatuses which are used for the preparation of fungicidal formulations are suitable for carrying out the process.

All methods known to the person skilled in the art as being customary can be used as application forms; the following may be mentioned by way of example: spraying, immersion, atomization and a number of special methods for direct underground or above-ground treatment of entire plants or parts (seed, root, stolons, stalk, trunk, leaf), such as, for example, trunk injection in the case of trees or stalk bandages in the case of perennial plants, and a number of special indirect application methods.

The respective area-related and/or object-related application rate of crop protection agents of a very wide range of formulation types for controlling said harmful organisms varies very greatly. In general, the application media known to the person skilled in the art as customary for the respective field of use are used in the customary amounts for this purpose, such as, for example, from several hundred litres of water per hectare in the case of standard spray methods through a few litres of oil per hectare in the case of ultra-low volume aircraft application to a few millilitres of a physiological solution in the case of injection methods. The concentrations of the crop protection agents according to the invention in the corresponding application media therefore vary within a wide range and are dependant on the respective field of use. In general, concentrations which are known to the person skilled in the art as being customary for the respective field of use are used. Concentrations of 0.01% by weight to 99% by weight are preferred, particularly preferably from 0.1% by weight to 90% by weight.

The fungicidal formulations according to the invention can be broadcast, for example, in the preparation forms customary for liquid preparations, either as such or after prior dilution with water, i.e. for example as emulsions, suspensions or solutions. The application is effected by customary methods, i.e. for example by spraying, pouring or injecting.

The application rate of the fungicidal formulations according to the invention can be varied within a relatively large range. It depends on the respective fungicidal active substances and on the content thereof in the formulations.

The invention furthermore relates to a method for promoting the penetration of fungicidal active substances into plants, the fungicidal active substance being applied to the plant simultaneously or sequentially with one or more polyalkylene oxide derivatives of the formula (I).

Some of the crop protection agents according to the invention are known and some are novel.

The invention also relates to a crop protection agent containing
A) one or more agrochemical active substances from the group consisting of the fungicides
B) one or more polyalkylene oxide derivatives of the formula (I)

R^{a}—(CO)ₐ—[O]_{c}-(A)ₙ-(CO)_{b}—R^{b} (I)
in which the symbols and indices have the meanings stated above for the formula (I).

A preferred fungicide is fluopicolide.

The fungicidal compositions according to the invention contain as a rule 0.01 to 99% by weight, in particular 0.1 to 95% by weight, of one or more fungicidal active substances (A).

In spray powders, the active substance concentration is, for example, about 10 to 90% by weight, and the remainder to 100% by weight consists of customary formulation constituents and optionally surfactants (B). In the case of emulsifiable concentrants, the active substance concentration may be about 1 to 90, preferably 5 to 80% by weight. Dust-like formulations contain 1 to 30% by weight of active substance, preferably in general 5 to 20% by weight of active substance, and sprayable solutions contain about 0.05 to 80, preferably 2 to 50% by weight of active substance. In the case of water-dispersible granules, the active substance content depends in part on whether the active compound is present in liquid or solid form and which granulation auxiliaries, fillers, etc. are used. In the case of the water-dispersible granules, the content of active substance is, for example, between 1 and 95% by weight, preferably between 10 and 80% by weight.

The surfactants (B) to be used according to the invention are broadcast as a rule together with the fungicidal active substance or substances (A) or directly in succession, preferably in the form of a spray liquor which contains the surfactants (B) and the fungicidal active substances (A) in effective amounts and optionally further customary auxiliaries. The spray liquor is preferably prepared on the basis of water and/or an oil, for example a high-boiling hydrocarbon, such as kerosene or paraffin. The compositions according to the invention can be realized as a tank mix or via a “ready-to-use formulation”.

The weight ratio of fungicidal active substances (A) to surfactants (B) may vary within a wide range and depends, for example, on the activity of the fungicidal active substance. As a rule, it is in the range from 10:1 to 1:5000, preferably 4:1 to 1:2000, 4:1 to 1:200, 4:1 to 1:50, 2:1 to 1:10, 2:1 to 1:5, 2:1 to 1:2.

The application rates of the fungicidal active substances (A) are in general between 10 and 2000 g of a.s./ha (a.s.=active substance, i.e. application rate based on the active substance), preferably between 50 and 1000 g of a.s./ha. The application rates of surfactants (B) are in general between 1 and 5000 g of surfactant/ha, preferably 10 and 2000 g of surfactant/ha, in particular 20-1000 g of surfactant/ha, 20-500 g/ha, 50-500 g/ha.

The concentration of the surfactants (B) to be used according to the invention is as a rule from 0.05 to 4% by weight, preferably 0.1 to 1% by weight, in particular 0.1 to 0.3% by weight, of surfactant in a spray liquor.

In the case of harmful microorganisms, application to plants to be protected it from these harmful organisms is preferred. Methods for therapeutic use in humans and animals are excluded.

The invention furthermore relates to a method for controlling harmful microorganisms, preferably fungi or bacteria, particularly preferably fungi,
A) one or more agrochemical active substances from the group consisting of the fungicides,
B) one or more polyalkylene oxide derivatives of the formula (I),

R^{a}—(CO)ₐ—[O]_{c}-(A)ₙ-(CO)_{b}—R^{b} (I)

in which the symbols and indices have the abovementioned meanings, are applied, preferably in an effective amount, to the harmful microorganisms or the habitat thereof, preferably to plants to be protected from these harmful micro-organisms. Methods for therapeutic use in humans and animals are excluded.

The cultivated plants treated according to the invention are all economically important cultures, for example including transgenic cultures, of useful and decorative plants, for example of cereals, such as wheat, barley, rye, oats, millet, rice, manioc and maize, and also cultures of peanut, sugar beet, cotton, soya, rape, potato, tomato, pea and other vegetable varieties.

The invention is explained in more detail by examples without being limited thereto.

### EXAMPLES

### Penetration Test

In this test, the penetration of active substances through enzymatically isolated cuticles of apple tree leaves was measured.

Leaves which were cut off in the stage of full development of apple trees of the Golden Delicious variety were used. The isolation of the cuticles was effected in a manner such that
first leaf discs marked on the underside with dye and punched out were filled by means of vacuum infiltration with a pectinase solution (0.2 to 2% strength) buffered to a pH between 3 and 4, sodium azide was then added and
the leaf discs thus treated were allowed to stand until disintegration of the original leaf structure and detachment of the noncellular cuticle.

Thereafter, only those cuticles of the upper sides of the leaves which were free of staltoa and hairs were further used. They were washed several times alternately with water and a buffer solution at pH 7. The clean cuticles obtained were finally drawn onto small Teflon plates and smoothed and dried with a gentle air jet.

In the next step, the cuticle membranes thus obtained were placed in stainless steel diffusion cells (=transport chambers) for membrane transport investigations. For this purpose, the cuticles were placed by means of forceps centrally on the silicone grease-coated edges of the diffusion cells and closed with a likewise greased ring. The arrangement was chosen so that the morphological outside of the cuticles faced outwards, i.e. towards the air, while the original inside faced the interior of the diffusion cell. The diffusion cells were filled with water or with a mixture of water and solvent.

For determining the penetration, in each case 9 μl of a spray liquor of the composition mentioned in the examples were applied to the outside of a cuticle.

In each case tap water was used in the spray liquors.

After the application of the spray liquors, in each case the water was allowed to evaporate, and in each case the chambers were then turned around and were placed in thermostated trays, air having a defined temperature and atmospheric humidity being blown onto the outside of the cuticle. The incipient penetration therefore took place at a relative humidity of 60% and a set temperature of 25° C. The active substance penetration was measured with radioactively marked active substance.

As is evident from the examples shown in the tables, the presence of compounds of the formula (I) (as an example here, products from the Cithrol® series) leads to a considerable increase in absorption compared with the formulations in which the compounds of the formula (I) are not present. The alternatives to compounds in the formula (I) which are used are examples of commercially available solvents for formulations.

TABLE 1
Penetration of tebuconazole with polyalkylene oxide
derivatives of the formula (I) (surfactant)^{a}

| | | Pene- | Pene- | Pene- |
|---|---|---|---|---|
| | Tebuconazole | tration* | tration* | tration** |
| Formulation/ | concentration | after 5 | after 1 | after 2 days |
| surfactant | [g/l] | hours [%] | day [%] | [%] |
| Tebuconazole | 0.2 | 2 | 8 | 15 |
| (ai) | | | | |
| (active | | | | |
| substance | | | | |
| only) | | | | |
| Ai + 0.5 g/l | 0.2 | 17.7 | 58.4 | 75.7 |
| Cithrol 4DO | | | | |
| Ai + 0.5 g/l | 0.2 | 20.6 | 68.9 | 86.8 |
| Cithrol 4DL | | | | |

^{a}Mean values of 5-8 repetitions
*at 25° C., 60%

TABLE 2
Penetration of fluopicolide with polyalkylene
oxide derivatives of the formula (I)^{a}

| | Fluopicolide | Penetration* | Penetration* |
|---|---|---|---|
| Formulation/ | concentration | after 5 | after 1 day |
| surfactant | [g/l] | hours [%] | [%] |
| Fluopicolide (ai) | 0.25 | 0.2 | 0.6 |
| (active compound only) | | | |
| Ai + 0.5 g/l | 0.25 | 1.3 | 8.2 |
| Cithrol 4DO | | | |
| Ai + 0.5 g/l | 0.25 | 4.2 | 15.0 |
| Cithrol 4DL | | | |

^{a}Mean values of 5-8 repetitions
*at 25° C., 60%

1. Use of A method for promoting penetration of a fungicidal active substance into a plant comprising employing a polyalkylene oxide derivatives of the formula (I)
R^{a}—(CO)ₐ[O]_{c}-A—(CO)_{b}—R^{b} (I)
wherein
R^{a} is a C₈-C₃₀-hydrocarbon radical,
R^{b} is a C₈-C₃₀-hydrocarbon radical,
a is 0 or 1;
b is 0 or 1;
c is 0 or 1 and
A is one or more alkylene oxide units.

2. A method according to claim 1, wherein the polyalkylene oxide derivative of the formula (I) containing s alkylene oxide units A of the formula (II)
-(EO)ₓ(RO)_{y}(EO)_{z}— (II)
in which
EO denotes an ethylene oxide unit;
RO denotes a unit —CHR^{x}—CHR^{y}—O—, R^{x}, R^{y}, independently of one another, denoting H or (C₁-C₄)alkyl;
x denotes an integer from 0 to 600;
y denotes an integer from 0 to 600;
z denotes an integer from 0 to 600;
the sum (x+y+z) being≧2 and ≦600.

3. A method according to claim 1, wherein the polyalkylene oxide derivative is a compound of formulae I-1) to I-3):
I-1) R^{a}—O-A-R^{b},
I-2) R^{a}—CO—O-A-R^{b}, and/or
I-3) R^{a}—CO—O-A-CO—R^{b}.

4. A method according to claim 3, wherein a polyalkylene oxide derivative of the formulae (I-11), (I-22) or (I-33) is used,
I-11) (C₁₀-C₂₄) alkyl-O—[(EO)ₓ(PO)_{y}]—(C₁₀-C₂₄)alkyl
I-22) (C₉-C₂₃)alkyl-CO—O—[(EO)ₓ(PO)_{y}]—(C₁₀-C₂₄)alkyl
I-33) (C₉-C₂₃)alkyl-CO—O—[(EO)ₓ(PO)_{y}]—CO(C₉-C₂₃)alkyl,
in which
x is an integer from 0 to 600;
y is an integer from 0 to 600 and
x+y is an integer≧1 and ≦600.

5. A method according to claim 1, wherein the polyalkylene oxide derivatives is of the formula (III) 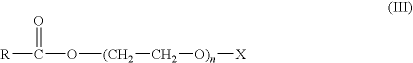
in which
R is an oleyl, stearyl or lauryl radical;
n is a natural number from 2 to 20 and
X is H or —C(O)R.

6. A method of claim 1 for promoting the penetration of a fungicidal active substance in plant, comprising applying fungicidal active substance to the plant simultaneously or sequentially said polyalkylene oxide derivative of the formula (I).

7. A crop protection agent comprising
A) at least one agrochemical active substance selected from the group consisting of fungicides,
B) at least one polyalkylene oxide derivative of the formula (I)
R^{a}—(CO)ₐ—[O]_{c}-(A)ₙ-(CO)_{b}—R^{b} (I)
wherein
R^{a} is a C₈-C₃₀-hydrocarbon radical,
R^{b} is a C₈-C₃₀-hydrocarbon radical,
a is 0 or 1;
b is 0 or 1;
c is 0 or 1 and
A is one or more alkylene oxide units.

8. A method for controlling harmful microorganisms, comprising applying thereto or to a habitat thereof:
A) at least one agrochemical active substance selected from the group consisting of fungicides,
B) at least one polyalkylene oxide derivative of formula (I)
R^{a}—(CO)ₐ—[O]_{c}-(A)ₙ-(CO)_{b}—R^{b} (I)
wherein
R^{a} is a C₈-C₃₀-hydrocarbon radical,
R^{b} is a C₈-C₃₀-hydrocarbon radical,
a is 0 or 1;
b is 0 or 1;
c is 0 or 1 and
A is one or more alkylene oxide units.

9. A method according to claim 2, wherein the polyalkylene oxide derivative is a compound of the following formulae I-1) to 1-3):
I-1) R^{a}—O-A-R^{b},
I-2) R^{a}—CO—O-A-R^{b}, and/or
I-3) R^{a}—CO—O-A-CO—R^{b}.

10. A method according to claim 2, wherein the polyalkylene oxide derivatives is of formula (III) 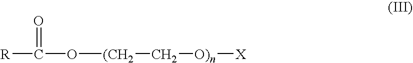
in which
R is an oleyl, stearyl or lauryl radical;
n is a natural number from 2 to 20 and
X is H or —C(O)R.

11. A method according to claim 3, wherein the polyalkylene oxide derivatives is of formula (III) 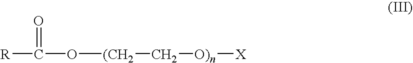
in which
R is an oleyl, stearyl or lauryl radical;
n is a natural number from 2 to 20 and
X is H or —C(O)R.

12. A method according to claim 4, wherein the polyalkylene oxide derivatives is of formula (III) 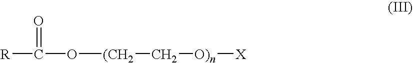
in which
R is an oleyl, stearyl or lauryl radical;
n is a natural number from 2 to 20 and
X is H or —C(O)R.

13. A method of claim 1, wherein R^{a} and R^{b} are C₈-C₃₀ alkyl, C₈-C₃₀ alkenyl or C₈-C₃₀ alkynyl.

14. A agent of claim 7, wherein R^{a} and R^{b} are C₈-C₃₀ alkyl, C₈-C₃₀ alkenyl or C₈-C₃₀ alkynyl.

15. A method of claim 8, wherein R^{a} and R^{b} are C₈-C₃₀ alkyl, C₈-C₃₀ alkenyl or C₈-C₃₀ alkynyl.
